(19) United States
(12) Patent Application Publication
(10) Pub. No.: US 2015/0302214 A1
(43) Pub. Date: Oct. 22, 2015

(54) FEDERATED PATIENT GUARANTEED UNIQUE IDENTIFICAITON (GUID) MATCHING

(71) Applicant: KONINKLIJKE PHILIPS N.V., EINDHOVEN (NL)

(72) Inventors: Brian David Gross, North Andover, MA (US); Nicolas Wadih Chbat, White Plains, NY (US)

(21) Appl. No.: 14/418,109

(22) PCT Filed: Jul. 24, 2013
(86) PCT No.: PCT/IB2013/056055

§ 371 Date: Jan. 29, 2015

Related U.S. Application Data
(60) Provisional application No. 61/678,373, filed on Aug. 1, 2012.

(51) Int. Cl. G06F 21/60; G06F 17/30; G06F 21/62

(52) U.S. Cl. CPC G06F 21/606; G06F 21/6245; G06F 17/30424; G06Q 50/24

(57) ABSTRACT

A method includes receiving patient data for a patient in electronic format. The patent data includes information that identifies the patient. The method further includes labeling the patient data with a guaranteed unique identifier. The method further includes at least one of removing or visually obscuring any information in the patient data that identifies the patient. The method further includes conveying, electronically, the labeled patient data to a third party remote computing/storage service. The labeled patient data is stored at the remote computing/storage service without any information in the patient data that identifies the patient.

The following generally relates to a method for managing medical applications and information. However, the following is also amenable to transportation performance, banking, financial records, school performance, tracking students' progress, and/or other applications.

Applications and information can be stored or operated in a number of environments. One particular environment that may be of interest is the “Cloud”. Cloud computing, generally, is the delivery of computing and/or storage capacity as a service to a community of end-recipients in which end users can access cloud-based applications through a web browser, a mobile app, etc. while the software and data are stored on servers at a remote location. With cloud computing, a user may merely rent the use of one or more servers provided by one or more cloud providers, rent use of the system software to use in the servers, and/or rent application software and databases.

In any instance, the cloud providers manage the infrastructure and platforms on which an applications run. Cloud computing could be very advantageous in the healthcare space. For example, a CDS system has included computer software that assists clinicians and/or other health professionals with decision making tasks such as determining a diagnosis of patient data. With a cloud based CDS system, computing based on patient data and optionally storage of at least some of the patient data can be provided as a cloud service that assists clinicians and/or other health professionals with decision making tasks such as determining a diagnosis of patient data.

A cloud based CDS system could offer several distinct advantages over a site-hosted and managed CDS system. These advantages include, but are not limited to, a single knowledge base deployment location that will update all subscribing sites to the same level of evidence at once, reduction in deployment time, automatically updates the reporting performance measures collected from the CDS system, and reduced cost for deployment and maintenance. However, an impediment to deploying patient data to the cloud is the concern over privacy and security of the patient data payload. In view of the foregoing, there is an unresolved need for other cloud based CDS approaches.

Aspects described herein address the above-referenced problems and others.

In one aspect, a method includes receiving patient data for a patient in electronic format. The patient data includes information that identifies the patient. The method further includes labeling the patient data with a guaranteed unique identifier. The method further includes at least one of removing or visually obscuring any information in the patient data that identifies the patient. The method further includes conveying, electronically, the labeled patient data to a third party remote computing/storage service. The labeled patient data is stored at the remote computing/storage service without any information in the patient data that identifies the patient.

In another aspect, a method includes waking a clinical decision support service engine from an idle state, instructing the clinical decision support service engine to obtain patient data for a patient based on corresponding guaranteed unique identifier, sending a request for the patient data using the guaranteed unique identifier, and receiving the request patient data, wherein the identity of the patient is not included in the patient data.

In another aspect, a site includes a patient to guaranteed unique identifier map that maps each patient to a unique guaranteed unique identifier and a site server that labels patient data for a patient with a guaranteed unique identifier corresponding to the patient from the patient to guaranteed unique identifier map and at least one of removes or visually obscures any information in the patient data that identifies the patient, and that conveys the labeled patient data to a remote computing/storage service.

In another aspect a method includes receiving, at a cloud based CDS system, a query from a healthcare entity of a group of federated healthcare entities, wherein the query includes at least a guarantee unique identifier for a patient, which is generated by the healthcare entity, but does not include an identity of the patient, identifying at least one guaranteed unique identifier stored on the cloud based CDS corresponding to another patient previously registered at another of the healthcare entities and that is likely to be a same patient as the queried patient, generating a signal indicative of the at least one guaranteed unique identifier of the patient previously registered at the other of the healthcare entity, and sending the signal to the querying healthcare entity.

The invention may take form in various components and arrangements of components, and in various steps and arrangements of steps. The drawings are only for purposes of illustrating the preferred embodiments and are not to be construed as limiting the invention.

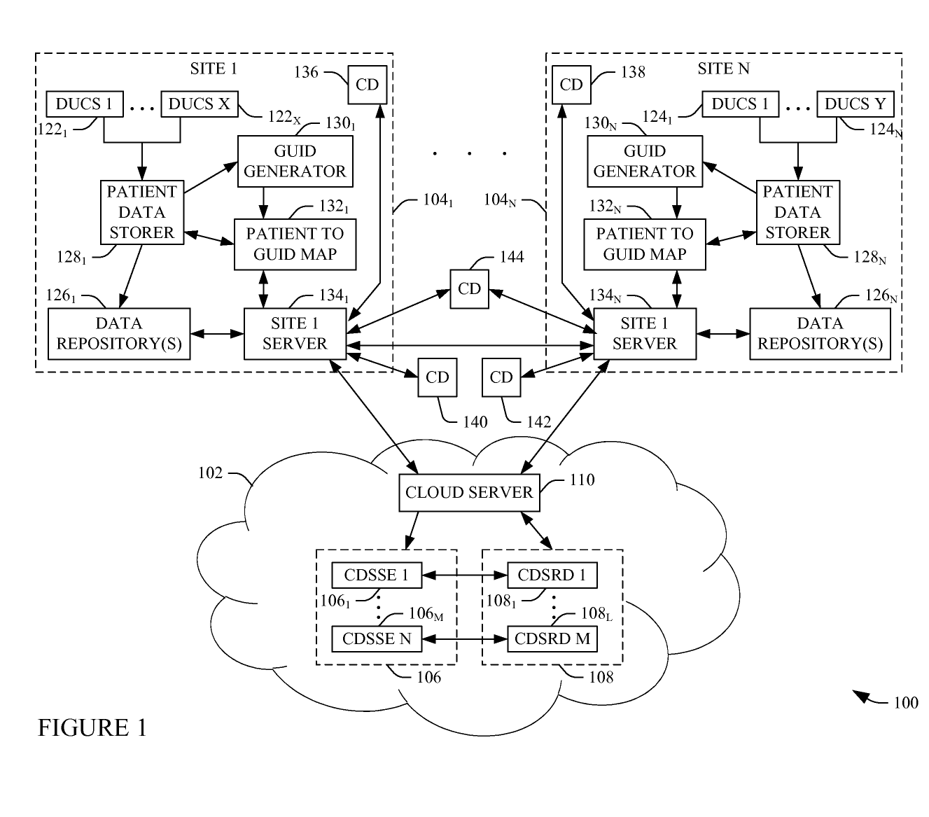

FIG. 1 schematically illustrates an example system with a cloud-based CDS system and multiple sites in which patient data is stored locally at the sites.

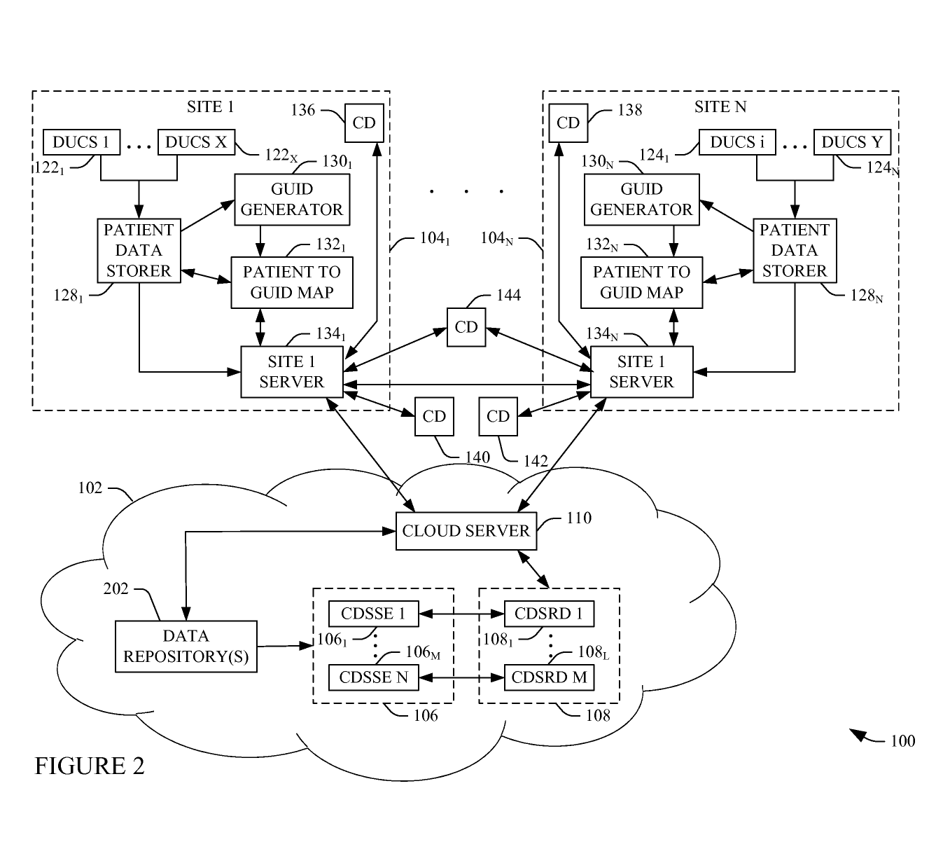

FIG. 2 schematically illustrates another example system with the cloud-based CDS system and multiple sites in which patient data is stored at the cloud.

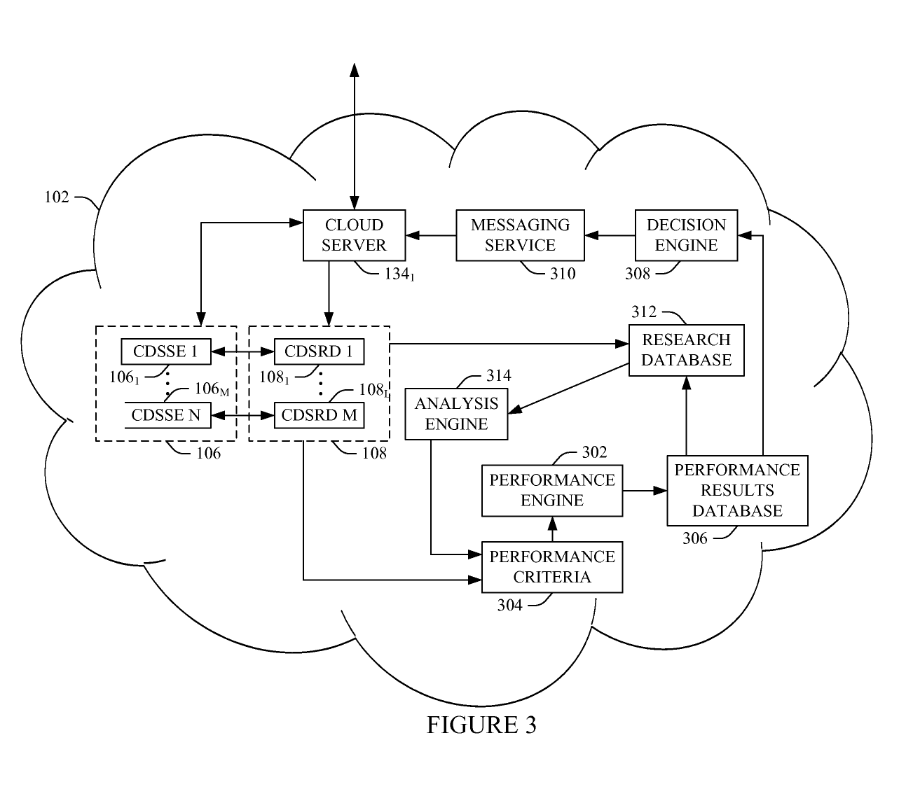

FIG. 3 schematically illustrates another example of the cloud-based CDS system.

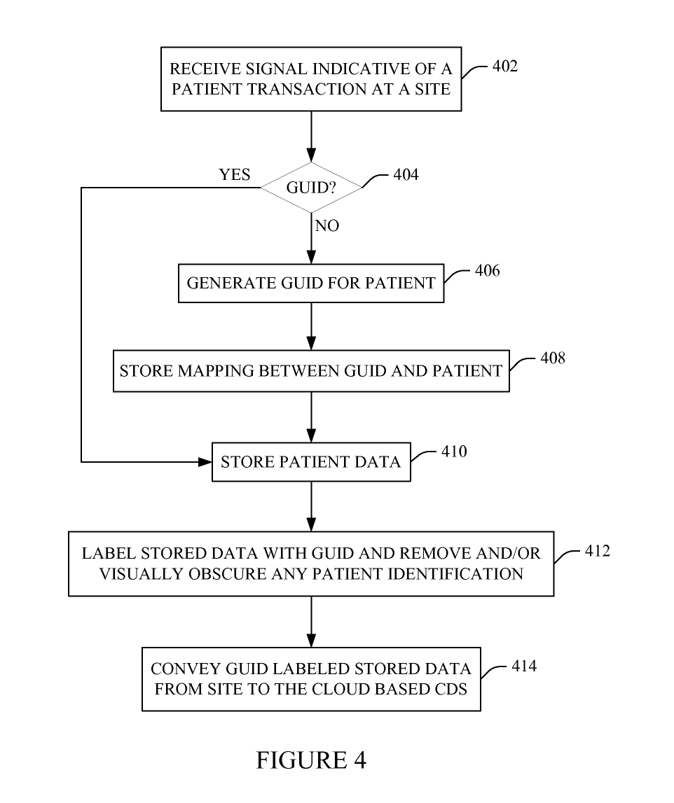

FIG. 4 illustrates an example for conveying data of a patient to a cloud based CDS for storage without revealing the patient identity to the cloud based CDS while establishing a mapping from the patient to the stored data.

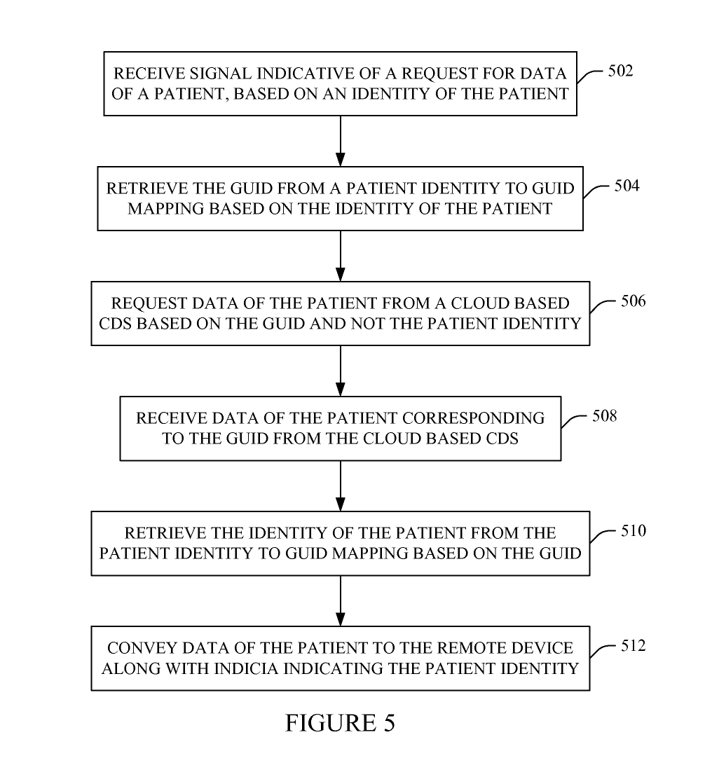

FIG. 5 illustrates a method for providing data of a patient that is stored in a cloud based CDS to a computing device requesting the data without revealing the identity of the patient to the cloud based CDS.

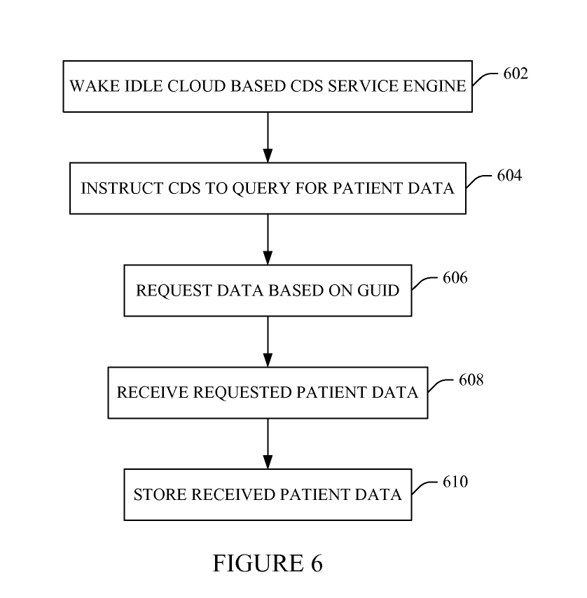

FIG. 6 illustrates a method for pulling data of a patient to a cloud based CDS without revealing the identity of the patient to the cloud based CDS.

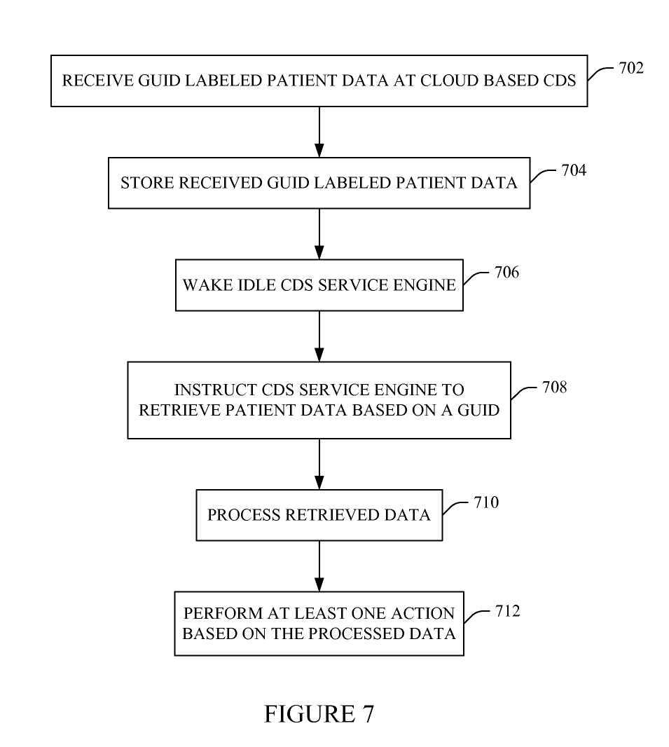

FIG. 7 illustrates a method for pushing data of a patient from a cloud based CDS to a computing device without revealing the identity of the patient to the computing device.

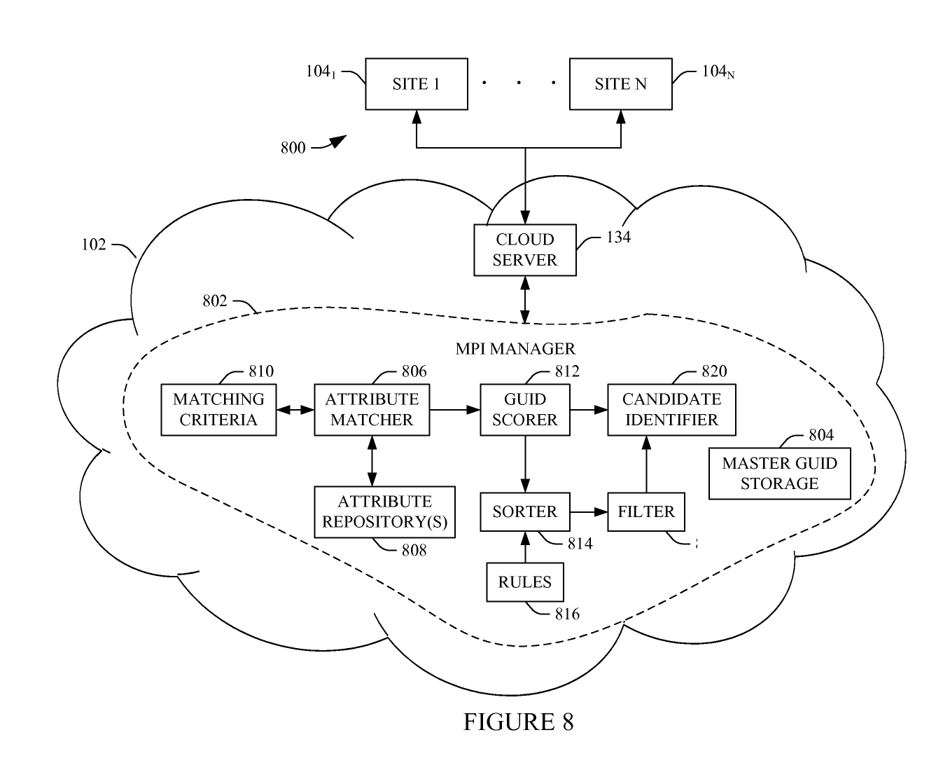

FIG. 8 schematically illustrates another example system with the cloud-based CDS system and a master patient index manager.

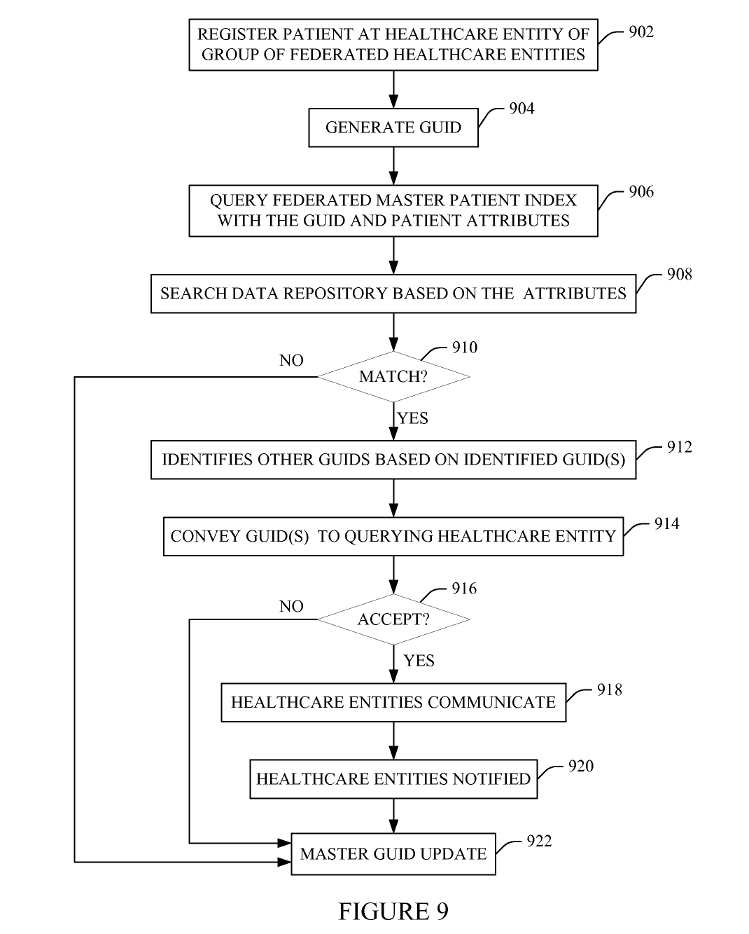

FIG. 9 illustrates example method for matching a newly generated local GUID with a local GUID(s) for a patient(s) likely to be the same patient.

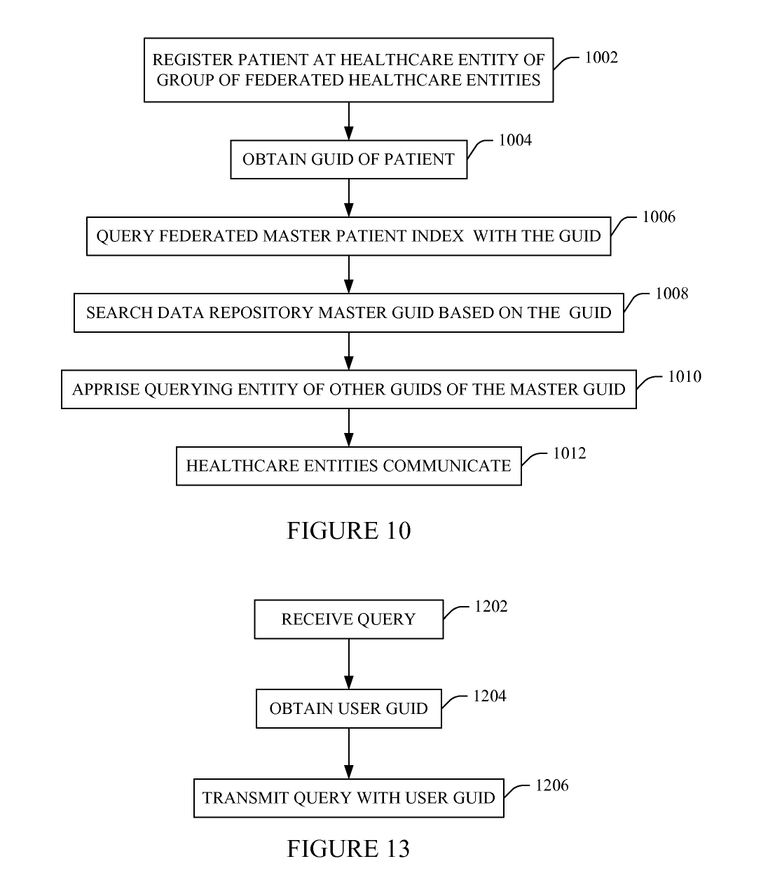

FIG. 10 illustrates an example method for querying for patient information from healthcare entities of a group of federated healthcare entities by a healthcare entity of the group based on a GUID.

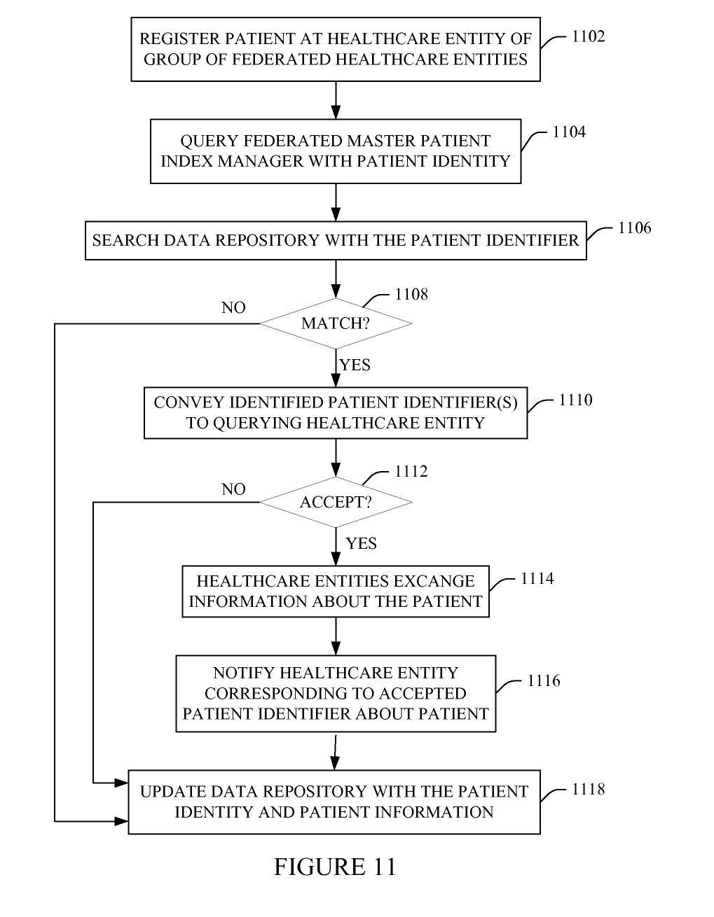

FIG. 11 illustrates an example method for matching a first time registered patient at a healthcare entity of a group of federated healthcare entities with patient identifiable information.

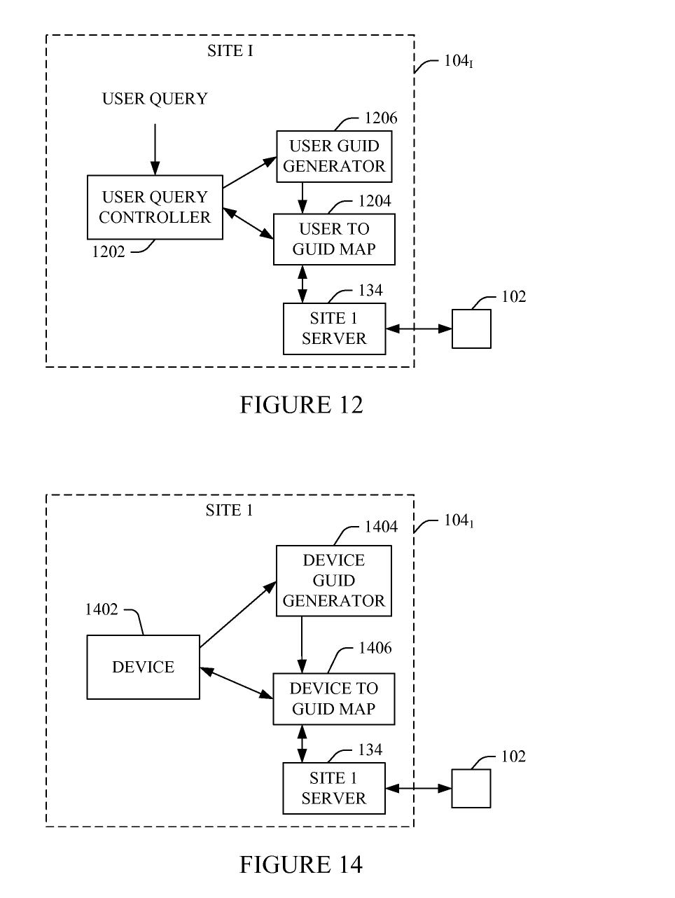

FIG. 12 schematically illustrates another example system with the cloud-based CDS system and a user GUID controller.

FIG. 13 illustrates example method for query the cloud-based CDS system and including a user GUID.

FIG. 14 schematically illustrates an example system with the cloud-based CDS system and a device.

Initially referring to FIG. 1, a system 100 includes a cloud-based CDS system 102 and N sub-system sites 104₁, . . . , 104_{N} (collectively referred to as sub-system sites 104), where N is an integer equal to or greater than one (1).

The cloud-based CDS system 102 provides cloud-based CDS computing and/or storage services. In the illustrated embodiment, the cloud-based CDS system 102 includes M CDS service engines (CDSSE) 106₁, . . . , 106_{M} (collectively referred to as CDSSE's 106), where M is an integer equal to or greater than one (1). Each one of the CDSSE's 106 provides one or more predetermined services. The CDSSE's 106, generally, are configured to query the sub-system sites 104 for patient data based on a schedule, an event, on-demand, etc., and, optionally, process the data.

The cloud-based CDS system 102 also includes L corresponding CDS results databases (CDSRD) 108₁, . . . , 108_{L} (collectively referred to as CDSRD's 108), where L is an integer equal to or greater than one (1). In the illustrated embodiment, M=L, and each of the CDSSE's 106 has a corresponding one of the CDSRD's 108. In this instance, each of the CDSRD's 108 stores results of queries and/or processed results of queries from a corresponding one of the CDSSE's 106.

A cloud server 110 allows for communication between the cloud-based CDS system 102 and one or more of the sub-system sites 104 and/or other device, apparatus, system, etc., external to the cloud-based CDS system 102. Optionally, the cloud server 110 includes encryption/decryption capabilities. Where configured with such capabilities, encrypted information received by the cloud-based CDS system 102 can be decrypted by the cloud server 110, and information conveyed from the cloud-based CDS system 102 can be first encrypted.

The sub-system site 104₁ includes X department/unit computing systems (DUCS) 122₁, . . . , 122_{X} (collectively referred to as DUCS 122), where X is an integer equal to or greater than one (1), and the sub-system site 104_{N} includes Y DUCS 124₁, . . . , 124_{Y} (collectively referred to as DUCS 124), where Y is an integer equal to or greater than one (1). In one instance, X is equal to Y (i.e., X=Y). In another instance, X is equal to Y (i.e., X≠Y). In the latter instance, X and be greater than Y (i.e., X>Y) or less than Y (i.e., X<Y).

Examples of the sub-system sites 120 include, but are not limited to, hospitals, clinics, thru cares, doctors' offices, imaging centers, etc. Examples of suitable departments/units include, but are not limited to, an admitting/discharge/transfer (ADT) department, emergency room (ER), a laboratory, an intensive care unit (ICU), a coronary care unit (CCU), etc. The DUCS 122 and 124 of the site 104₁, . . . , 104_{N} can convey information via Health Level Seven (HL7) and/or other protocols.

The sub-system sites 104₁, . . . , 104_{N} further include data repositories 126₁, . . . , 126_{N}, which at least store patient data, including patient data from the department/unit computing systems 122 and 124. The data repositories 126₁, .., 126_{N} can be updated with information from the department/unit computing systems 122 and 124 based on a time schedule, an occurrence of a patient transaction (e.g., admission of a patient), an event, and/or otherwise. Patient data storers 128₁, . . . , 128_{N} update the data repositories 126₁, . . . , 126_{N}.

The sub-system sites 104₁, . . . , 104_{N} further include guaranteed unique identifier generators 130₁, . . . , 130_{N}, which generate a unique identifier for a patient. For example, in one non-limiting instance, the guaranteed unique identifier generators 130₁, . . . , 130_{N} generate a thirty-two (32) or other number bit alpha-numeric string based on a random number generated from a clock, computer, server and/or other source seed and/or other information. Optionally, a media access control (MAC) address of the generator 130₁, . . . , 130_{L} can also be used, which encodes site location (e.g., longitude and latitude information) in the GUID and/or watermark geographic location or domain in the GUID. The location information may be used for patient matching and/or otherwise, such as for surveillance reports, outbreak dissemination, etc.

The sub-system sites 104₁, . . . , 104_{N} further include patient to GUID maps 132₁, . . . , 132_{N} (collectively referred to herein as patient to GUID maps 132), which store a mapping between a patient and their GUID. In one instance, the patient data is stored in the data repositories 126 without the GUID, and the GUID for a particular patient or patient data is obtained from the patient to GUID maps 132. In another instance, one or more GUIDs are stored in the data repositories 126 along with the patient data.

The sub-system sites 104₁, . . . , 104_{N} further include site servers site 1 server 134₁, . . . , site N server 134_{N}, which allow network communication between the sub-system sites 104 and the cloud-based CDS system 102 (and/or other computing systems) through the server 110. Optionally, the site servers 134₁, . . . , 134_{N} include encryption/decryption capabilities. Where configured with such capabilities, information conveyed from the sites 104₁, . . . , 104_{N} is first encrypted, and encrypted information received by the sites 104₁, . . . , 104_{L} is decrypted.

In the illustrated embodiment, the servers 134 facilitate removal and/or visually obscuring of patient identity information in the data of a patient before conveying such data to the cloud-based CDS system 102. Removing may include literally removing patient identity and/or replacing patient identity with the corresponding GUID from the patient to GUID maps 13 or otherwise labeling the patient data with the GUID. Visually obscuring patient identity includes, but is not limited to, overlaying a watermark, pattern, etc. over patient identity.

As such, the data of a patient at the cloud-based CDS system 102 is non-identifiable in that is does not contain any information that identifies the patient by patient identity. Rather, such data is labeled and accessed at the cloud-based CDS system 102 based on the corresponding GUID. In one instance, this mitigates the impediment to conveying data of a patient to the cloud due to a concern over privacy and security of the patient since the conveyed data of the patient does not include any information that identifies who the patient actually is.

One or more computing devices (CD) 136, 138, 140, 142 and 144 employ the software applications, which can communicate with the cloud entity 103 through the servers 134₁, . . . , 134_{N}. Examples of the one or more computing devices 136, 138, 140, 142 and 144 include desktops, laptops, tablet computers, and the like. Such devices can be part of bedside monitors, portable monitoring units, hand-held monitoring units, a central monitoring station, etc. In the illustrated embodiment, the computing device 136 is part of the sub-system site 104₁ and communicates with the cloud-based CDS system 102 through the site 1 server 134₁, and the computing device 138 is part of the sub-system site 104_{N} and communicates with the cloud-based CDS system 102 through the site 2 server 134_{N}.

The computing device 140 is external to the sub-system site 104₁ and communicates with the cloud-based CDS system 102 through the site 1 server 134₁, and the computing device 142 is external to the sub-system site 104₂ and communicates with the cloud-based CDS system 102 through the site 2 server 134_{N}. The computing device 144 is external to the sub-system sites 104₁ and 104_{N} and communicates with the cloud-based CDS system 102 respectively through the sub-system site 1 server 134₁ and/or the sub-system site 2 server 134_{N}. Authorization and/or authentication of a user of a device 136-144 can be handled by the sub-system sites 104, e.g., through the servers 134 and/or otherwise.

The servers 134 also facilitate querying the cloud-based CDS system 102 for data based on patient identity and identifying a patient identity for queried data. For example, where one of the computing devices 136-144 queries for data for a specific patient, the corresponding server 134 locates the GUID for the patient and facilitates removal and/or visually obscuring of patient identity information in the data of a patient before conveying the query to the cloud entity 102. This renders the query non-identifiable in that the query does not include any information about the patient identity.

Upon retrieving the data from the CDSRD's 108, the cloud-based CDS system 102 conveys the data via the server 134 to the one of the computing devices 136-144. For queried data, the corresponding server 134 locates the patient identity for the GUID in the patient to GUID map 132. The server 134 then adds and/or associates the patient identity to the data, replaces the GUID in the data with the patient identity, and/or removes any visual obscuring. The patient data is now patient identifiable in that the data includes the patient identity, and the data is conveyed to the one of the computing devices 136-144.

It is to be appreciated that the various components of the cloud-based CDS system 102 and/or sites 104 can be implemented via one or more microprocessor executing computer readable and executable instructions stored on computer readable storage medium such as physical memory and/or other non-transistory medium. Additional or alternatively, the one or more microprocessor can execute readable and executable instructions carried by a carrier wave, signal and/or other transitory medium.

FIG. 2 illustrates an embodiment in which the cloud-based CDS system 102 includes one or more data repositories 202 which stores the data of the patients. In the illustrated embodiment, the data repositories 126 of the sub-system sites 104 are omitted. However, in a variation, the system 100 can include both the data repositories 126 of the sub-system sites 104 and the one or more data repositories 202 at the cloud-based CDS system 102.

Similar to the embodiment of FIG. 1, the servers 134 remove and/or visually obscure patient identity information in the data of a patient and associate the GUID thereto before conveying such data to the cloud-based CDS system 102. In this instance, patient identity is removed from the patient data and stored in the one or more data repositories 202 using the GUID. As such, each time new data becomes available, the patient identity is removed, the GUID is associated with the data, and the data is conveyed to the cloud entity 102.

In contrast, in FIG. 1, the data of the patients can be stored in the data repositories 132 with the patient identity and/or GUID, and the patient identity is removed and/or obscured only when the data is requested by the cloud-based CDS system 102.

FIG. 3 illustrates another embodiment of the cloud-based CDS system 102.

In this embodiment, the cloud-based CDS system 102 further includes a performance engine 302 and performance criteria 304. The patient data stored in the results databases 108 represents a single normalized point of knowledge, and the performance engine 302 can process this data based on the performance criteria 304. By way of non-limiting example, the performance criteria 304 may include criteria that indicates a patient in the ER with chest pain should have an ECG within ten minutes of the emergency room learning of this symptom.

In this instance, the performance engine 302 can evaluate the data of such patients in the results databases 108 on a sub-system site by sub-system site or other basis to determine which sub-system sites comply with the performance criteria and optionally a frequency and/or percentage of their compliance, for example, on a per encounter, unit, institutional and/or other basis. The performance engine 302 can utilize this information to then compare sub-system sites to see which comply most often, more than a predetermined threshold amount of the time, less than a predetermined acceptable amount, etc. The results are stored in a performance results data base 306.

A decision engine 308 analyzes the performance results in the performance results database 306 and renders decisions based thereon. For example, where a sub-system site complies with the performance criteria, the decision engine 308 may invoke a messaging service 310 to send a message to the sub-system site and/or an insurance company, which may use the data to determine whether to reimburse the sub-system site, target quality and process improvement opportunities and progress , etc. Additionally or alternatively, where a sub-system site does not comply, the decision engine 308 may invoke the messaging service 310 to send a message indicating such.

In another instance, the decision engine 308 may invoke the messaging service 310 to send a message indicating the performance criteria and/or indicating that the performance criteria is about to lapse without being satisfied. In the latter case, for example, where the performance criteria indicates the patient with chest pain should have an ECG within ten minutes, the message may indicate the six minutes has passed and/or four minutes remain. The message can be sent to a bedside monitor, a pager, a smartphone, a central monitoring station, email, application residing on the CD, etc.

A research database 312 stores data aggregated and created for the patient encounter, including, but not limited to, the performance results as well as other patient data, such as data from the CDS results databases 108, including high fidelity data such as physiologic measurements (e.g., BP, heart rate, etc.), which, generally, are sampled at a higher frequency relative to measurements manually recorded by a clinician. This data can be persisted and used for as long as the cloud-based CDS system 102 is operating and/or otherwise.

An analysis engine 314 processes the data in the research database 312. In one instance, analysis results of such processing may be used update the performance criteria and/or create an alert or advisory based on a single patient or cohort trends. For example, where the performance criteria indicates that a particular test should be performed within a predetermined time from some reference point (e.g., admission) and the research results indicate the all or number of sites perform this test in half the time, then the criteria may be updated with a reduce time.

FIGS. 4-7 illustrates example methods in accordance with the system 100 of FIGS. 1,2 and/or 3.

It is to be appreciated that the ordering of the acts in the methods described herein is not limiting. As such, other orderings are contemplated herein. In addition, one or more acts may be omitted and/or one or more additional acts may be included.

Initially referring to FIG. 4, a method for conveying data of a patient to a cloud based CDS system for storage without revealing the patient identity to the cloud based CDS system while establishing a mapping from the patient to the stored data is illustrated.

At 402, a signal indicative of the patient transaction at a sub-system site is received.

At 404, it is determined whether the patient is associated with a guaranteed unique identifier (GUID).

If not, then at 406, a GUID is generated for the patient.

At 408, a mapping of the GUID to the patient is stored.

If so or after the GUID is generated, at 410 patient data from the transaction is stored.

At 412, upon a request for patient data from a cloud-based CDS system, the patient identification of the stored data is removed and/or visually obscured, and the stored data is labeled with the GUID for the patient at the site .

At 414, the GIUD labeled stored transaction data is conveyed from the sub-system site to the cloud-based CDS system, where it can be processed and with processed results stored therein.

Next at FIG. 5, a method for providing data of a patient that is stored in a cloud based CDS to a remote computing device requesting the data without revealing the identity of the patient to the cloud based CDS system is illustrated.

At 502, a signal indicative of a request for data of a particular patient(s) based on an identity of the patient is received from a remote computing device.

At 504, a GUID for the patient(s) is retrieved from a patient identity to GUID mapping based on the patient identity at the site.

At 506, a request for the data of the patient using the GUID, and not the patient identity, is sent to the cloud-based CDS system.

At 508, data of the patient corresponding to the GUID is received from the cloud-based CDS system.

At 510, the patient identity is retrieved from the patient to GUID mapping based on the GUID.

At 512, the data of the patient is conveyed to the remote computing device along with indicia indicating the patient identity.

As an example, in one non-limiting instance, the remote device can be a bedside monitor and the data of the patient, which is received from the cloud based CDS system without revealing the patient identity to the cloud based CDS system, can be visually presented with the indicia identifying the patient.

Turning to FIG. 6, a method for pulling data of a patient to a cloud based CDS system without revealing the identity of the patient to the cloud based CDS system is illustrated.

At 602, an idle CDS service engine is woken.

At 604, the CDS service engine is instructed to query a data repository of a sub-system site or the cloud-based CDS system for particular patient data.

At 606, the CDS service engine requests the data based on a GUID, without knowing the patient identity.

At 608, the CDS service engine receives the requested data of the patient.

At 610, the CDS service engine processes and stores the requested particular data of the patient.

FIG. 7 illustrates a method for pushing data of a patient from a cloud based CDS system without revealing the identity of the patient to a remote computing device.

At 702, data of a patient is received, wherein the data is identified through a GUID and not through an identity of the patient.

At 704, the received data of the patient is stored.

At 706, an idle CDS service engine is woken.

At 708, the CDS service engine is instructed to retrieve particular data of a patient from the stored data based on a GUID.

At 710, the retrieved data is processed.

At 712, the CDS service engine performs at least one action, based on a result of the processing. The action may include calculating a new wave up time once set to idle, sending information to a site, a remote computing device and/or other device.

FIG. 8 schematically illustrates an example in which the sites 104 are part of a group of federated healthcare entities 800. As discussed in connection with FIG. 1, each site 104 locally generates GUIDs for its patients and stores the local GUIDs along with patient identifiers in the patient to GUID maps 132. As discussed in connection with FIG. 2, the cloud based CDS 102 may also include the one or more data repositories 202 that store patient information that is identified based on the local GUIDs, and not on actual patient identification.

In this embodiment, the cloud based CDS 102 further includes a master patient index (MPI) manager 802. Note the CDSSE's 106, the CDSRD's 108 and/or some other previously discussed components of the cloud based CDS 102 have been omitted in the illustration for sake of clarity. The master patient index manager 802 includes master GUID storage 804 that stores master GUIDs. Generally, a master GUID, for example, is a single GUID that links local GUIDs (e.g., as child GUIDs of the master GUID, etc.) generated by the individual sites 104 for a patient considered likely to be a same patient.

The cloud based CDS 102 further includes an attribute matcher 806. The attribute matcher 806 matches attributes provided by a site 104 (which are provided along with the local GUID generated by the site 104 and optionally location (e.g., latitude and/or longitude) information of the site 104) with patient attributes stored in the one or more data attribute repositories 808 of the cloud based CDS 102, which are stored with corresponding local GUIDs. In the illustrated embodiment, the attribute matcher 806 matches attributes based on predetermined matching criteria 810.

Example of suitable criteria 810 includes numeric criteria such as date of birth, age, height, weight, etc., coded data criteria such as religion, race, gender, etc., residential address, work address, telephone number, account number, clinical reason for registering with a site 104, laboratory results, diagnoses, physical characteristics such as amputated right leg, eye color, hair color, etc., genomics, prescriptions, anatomy of interest, region of interest, diagnostic imaging results, procedure results, procedure notes, tests results, and/or other clinical information.

A GUID scorer 812 determines and assigns a likelihood score to a GUID based on the matching. For example, where the attributes conveyed to cloud based CDS 102 for GUID A match a greater number of individual attributes corresponding to GUID B relative to GUID C, the GUID scorer 812 will assign a higher likelihood score to GUID B. The above is for a single attribute, however, the scores can be combined where each attribute is equally weighted or individually weighted using different weights, which allows for refining the matching based on an attribute of interest and/or other attribute.

A match can be a perfect match, e.g., GUID A and GUID B attributes both indicate blues eyes so this match is assigned a value of one (on a scale from 0 to 1), whereas GUID C indicates brown eyes so this match is assigned a value of zero. A GUID indicating green, hazel, or including some blue may be assigned a value between zero and one. The match can alternatively be a tolerance based match, e.g., GUID A attributes indicate 5′11″ and GUID B attributes indicate 5′10 ½″ where the criteria includes a tolerance of plus or minus one inch and again the attribute is assigned a value of one. Alternatively, the value may decrease the larger the difference is between the two attributes.

The match can alternatively be a closest based match, e.g., GUID A attributes indicate curly hair, GUID B attributes indicate wavy hair, and GUID C attributes indicate straight, and the value assigned to the GUID B attribute is greater than the value assigned to the GUID C attribute. Where an attribute is not provided and/or not stored in the cloud based CDS 102, the particular attribute may not be included in determining an overall score, the particular attribute may be derived based on other information, etc. Other scoring approaches are also contemplated herein.

An optional sorter 814 sorts the local GUIDs based on predetermined rules 816. The rules 816 may indicate sorting the local GUIDs based on the total overall score. In another instance, the rules 816 may indicate sorting the local GUIDs based on the total score for a predetermined sub-set of the attributes, such as one or more, but not all of the attributes. In yet another instance, the rules 816 may indicate sorting the local GUIDs based on a predetermined weighting of the attributes or a sub-set of the attributes. In still another instance, the rules 816 may be based on a user input indicative of user preferred approach. Other rules are also contemplated herein.

An optional filter 820 filters the sorted local GUIDs. In one instance, the filter criteria includes location information, encounter information, etc. By way of example, where a candidate local GUID was created fifteen minutes before the subject GUID and the two sites are an hour away from each other, then the candidate local GUID is filtered and removed from the set of candidate local GUIDs. Other information can also be used to determine whether a candidate GUID is plausible or should be removed from the set of candidate local GUIDs.

A candidate identifier 820 generates a signal indicative of the GUIDs and/or sorted and/or filtered GUIDs along with their likelihood scores.

The cloud server 134 conveys the signal to the querying site 104. The site 104 can accept a candidate local GUID based on the likelihood score and/or otherwise, and convey a signal to the cloud server 134 indicative of the acceptance. In response thereto, the master patient index manager 802 can update the master GUID in master GUID storage 804 such that the master GUID that includes the accepted candidate local GUID now also includes the subject local GUID. The cloud server 134 can notify each site 104 with a GUID in the master GUID about the newly added local GUID.

A site 104 can also query the cloud based CDS 102 for a list of local GUIDs in the master GUID corresponding to the GUID of the querying site 104. The querying site 104 can then communicate with the other sites 104 about the patient. Such communication may include exchanging information between sites 104. The master patient index manger 802 may also automatically match information and notify sites 104 of any potential matches.

FIG. 9 illustrates an example method for matching a newly generated local GUID for a first time registered patient at a healthcare entity of a group of federated healthcare entities with a local GUID(s) for a patient(s) likely to be the same patient and that is generated by another healthcare entity(s) of the group of federated healthcare entities.

It is to be appreciated that the ordering of the acts in these methods is not limiting. As such, other orderings are contemplated herein. In addition, one or more acts may be omitted and/or one or more additional acts may be included.

At 902, a patient registers at a healthcare site 104 of a group of federated healthcare entities. In this example, the patient is new to the healthcare site 104 in that this is the first time this patient has registered at the healthcare site 104.

At 904, the healthcare site 104 generates a local (i.e., local to the entity, relative to the other entities and/or group) GUID for the patient.

At 906, the healthcare site 104 queries the master patient index manager 802 of the cloud based CDS 102 to determine whether the patient has registered at another healthcare site 104 of the group. In this example, the query includes the local GUID along with patient attributes and/or other information, but does not include any patient identifier or information that would lead to the identification of the patient.

At 908, the master patient index manager 802 searches a data repository 202 and/or 808 of the cloud based CDS, which stores patient information, attributes and GUIDs of patients who have previously registered at at least one of the healthcare entities of the group of federated healthcare entities, for a GUID(s) of a patient(s) likely to be the same patient, based on the attributes.

As described herein, a likelihood score, which indicates a likelihood that the patient corresponding to a GUID is the same patient as the queried patient, can be generated for each GUID. In addition, identified GUIDs can be filtered to remove GUIDs associated with patients under circumstances that rule them out, e.g., a patient that is concurrently registered at another entity and thus cannot be this patient.

At 910, if at least one GUID is identified as a candidate based on the attributes, then at 912 the master patient index manager 802 accesses a master GUID, which includes GUIDs generated by different entities and grouped together based on the likelihood of corresponding to the same patient, based on the at least one GUID and identifies another GUID(s), if there are any, of the master GUID.

At 914, the master patient index manager 802 conveys a signal indicating the GUID(s) and an identification of the corresponding healthcare entity(s) to the querying healthcare site 104.

At 916, if the querying healthcare entity accepts at least one of the GUIDs as corresponding to the same patient, then at 918 the querying healthcare entity communicates with the corresponding healthcare entity(s) to exchange information about the patient.

At 918, optionally or alternatively to act 918, the master patient index manager 802 conveys a signal to the healthcare entity(s) corresponding to the accepted GUID(s), notifying the entity(s) about the patient encounter at the querying healthcare site 104.

At 920, the master patient index manager 802 updates the data repository with the patient information and the attributes and the master GUID with the local GUID.

If no patient is identified at 910, then 920 is performed with a master GUID being created for the local GUID instead of being updated.

If no identified patient is accepted at 916, then 920 is performed with a master GUID being created for the local GUID instead of being updated.

FIG. 10 illustrates an example method for querying for patient information from healthcare entities of a group of federated healthcare entities by a healthcare entity of the group based on a GUID.

It is to be appreciated that the ordering of the acts in these methods is not limiting. As such, other orderings are contemplated herein. In addition, one or more acts may be omitted and/or one or more additional acts may be included.

At 1002, a patient registers at a healthcare site 104 of the group of federated healthcare entities 800. In this example, the patient is has registered with the healthcare site 104 before and has already been assigned a local GUID.

At 1004, the healthcare site 104 obtains the local GUID for the patient.

At 1006, the healthcare entity queries a master patient index manager 802 of a cloud based CDS to determine whether the patient has registered at another healthcare entity of the group. In this example, the query includes at least the local GUID, but does not include any patient identifier or information that would lead to the identification of the patient.

At 1008, the master patient index manager searches master GUIDs, each which includes GUIDs generated by different entities and grouped together based on the likelihood of corresponding to the same patient, for a master GUID including the local GUID.

At 1010, the master patient index manager 802, in response to identifying a master GUID that includes the local GUID, conveys a signal indicating the other GUID(s) along with an identification of the corresponding entity(s) to the querying site 104.

At 1012, the querying healthcare entity communicates with the corresponding healthcare entity(s) to exchange information about the patient.

FIG. 11 illustrates an example method for matching a first time registered patient at a healthcare entity of a group of federated healthcare entities with patient identifiable information, e.g., patient identifiers, for a patient(s) likely to be the same patient and already registered at another healthcare entity(s) of the group.

It is to be appreciated that the ordering of the acts in these methods is not limiting. As such, other orderings are contemplated herein. In addition, one or more acts may be omitted and/or one or more additional acts may be included.

At 1102, a patient registers at a healthcare site 104 of a group of federated healthcare entities 800. In this example, the patient is new to the healthcare site 104 in that this is the first time the patient has registered at the healthcare site 104.

At 1104, the healthcare site 104 queries a federated master patient index manager 802 of a cloud based CDS 102 to determine whether the patient has registered at another healthcare entity of the group of federated healthcare entities. In this example, the query includes a patient identifier such as a patient name, part of the patient's name, etc.

At 1106, the master patient index manager searches a data repository 202 and/or 808 of the cloud based CDS 102, which stores patient information along with patient identifiers of patients who had registered at at least one of the healthcare entities of the group of federated healthcare entities, for patients likely to be the same patient, based on the patient identifier.

As described herein, a likelihood score, which indicates a likelihood that the a patient identifier corresponds to the same patient as the queried patient, can be generated for each patient. In addition, identified patients can be filtered to remove patients associated with circumstances that rule that patient even though the likelihood score would suggest otherwise.

At 1108, if at least one patient is identified as likely to be the same patient, then at 1110 the master patient index manager 802 conveys a signal indicating the patient identifier(s) and an identification of the corresponding healthcare entity(s) to the querying healthcare site 104.

At 1112, if the querying healthcare site 104 accepts one of the identified patients as being the same patient, then at 1114 the querying healthcare site 104 communicates with the corresponding healthcare entity to exchange information about the patient.

At 1116, optionally or alternatively to act 114, the master patient index manager 802 conveys a signal to the healthcare entity(s) corresponding to the accepted patient identifier, notifying the entity(s) about the patient encounter at the querying healthcare site 104.

At 1118, the master patient index manager 802 updates the data repository with the patient information and the patient identification.

If no patient is identified at 1108, then 1118 is performed.

If no identified patient is accepted at 1112, then 1118 is performed.

The method discussed herein may be implemented by way of computer readable instructions, encoded or embedded on computer readable storage medium, which, when executed by a computer processor(s), cause the processor(s) to carry out the described acts. Additionally or alternatively, at least one of the computer readable instructions is carried by a signal, carrier wave or other transitory medium.

FIG. 12 shows a variation in which a site 104_{I} of the sites 104 also includes components for generating and managing user GUIDs. A user is anyone who accesses (e.g., views, creates, modifies, extracts, copies, etc.) any patient information in the cloud based CDS 102. For example, the user can be a physician, an admitting department clerk, the patient, a person authorized by the patient, etc.

In FIG. 12, a user query controller 1202 receives a query for user access to the cloud based CDS 102. The query at least includes the patient GUID corresponding to the particular patient and identification information of the particular. Patient GUID creation and/or use of a patient GUID is as described herein and/or otherwise. The user query controller 1202 communicates with the user to GUID map 1204 and retrieves a user GUID for the user, if such a mapping already exists, based on the user identification information.

If no such mapping exists, the user GUID generator 1206 generates a user GUID for the user. Once created, the user query controller 1202 can retrieve the user GUID for the user. The user query controller 1202 then transmits a signal indicative of the query to the cloud based CDS 102. The signal at least includes the patient GUID and the user GUID. The site 104₁, cloud based CDS 102 and/or other entity stores such information. This information can be used to identify who accessed cloud information, whose information was accessed, the nature of the access (i.e., view, create, etc.), etc.

FIG. 13 shows a method for query the cloud-based CDS system and including a user GUID.

At 1302, a query for user access to the cloud based CDS 102 is received.

At 1304, a user GUID for the user is retrieved. This may include obtaining a previously generated user GUID based on the identity of the user and/or obtaining a newly generated user GUID where the user was not previously generated for the user.

At 1306, the query is sent to the cloud based CDS 102 along with the patient GUID and the user GUID.

FIG. 14 shows another variation. In this variation, the site 104₁ includes at least one device 1402. In another variation, the system 100 (FIG. 1) includes the device 1402, but the device 1402 is located outside of the site 104₁. Examples of the device 1402 include, but are not limited to a ventilator, an IV pump, a pace maker, a thermal regulator, a monitor, and/or other devices. One or more other devices are also contemplated herein. The device 1402 can interact with the cloud based CDS 102 as discussed herein. This includes using a device GUID (and not including any information that indicates the actual identity of the device) to send data from the device 1402 to the cloud based CDS 102 and/or vice versa.

If a device GUID does not already exist for the device 1402, a device GUID generator 1404 generates a device GUID for the device 1402. To send data from the device 1402 to the cloud based CDS 102, the device 1402 first can request its device GUID. The device 1402 then transmits the data to the site 1 server 134. The site 1 server 134 retrieves the deice GUID for the device 1402 and transmits the data along with the device GUID to the cloud based CDS 102. The transmitted data can be stored and/or processed at the cloud based CDS 102. The device GUID isolates the cloud based CDS 102 from knowledge of the actual identity of the device 1402, while allowing the cloud based CDS 102 to store and/or process data therefrom.

To send a message (e.g., a command such as a closed loop or semi-closed loop control signal, a signal that changes an operation of the device, etc.) from the cloud based CDS 102 to the device 1402, the cloud based CDS 102 transmits the message along with the device GUID to the site 1 server 134. The site 1 server 134 maps the device GUID to the device 1402. The site 1 server 134 then sends the message to the device 1402. Where the message is a command, the command may need confirmation from authorized personnel before it is executed. The device GUID isolates the cloud based CDS 102 from knowledge of the actual identity of the device 1402, while allowing the cloud based CDS 102 to control the device 1402 and/or send control commands to the device 1402.

Examples of such control include, but are not limited to the following. Where the device 1402 is a ventilator, the message can change the mode of operation from a positive pressure to a pressure support mode, increase or decrease a tidal volume, increase or decrease an oxygen concentration, increase or decrease a pressure, etc. Where the device 1402 is an IV pump, the message can increase or decrease a fluid administration rate, etc. Where the device 1402 is a pace maker, the message can increase or decrease a capture current, increase or decrease a rate, etc. Where the device 1402 is a thermal regulator, the message can increase or decrease a set point, etc. Where the device 1402 is a monitor, the message can turn an alarm on or off, cause the display of particular information, etc.

The invention has been described with reference to the preferred embodiments. Modifications and alterations may occur to others upon reading and understanding the preceding detailed description. It is intended that the invention be constructed as including all such modifications and alterations insofar as they come within the scope of the appended claims or the equivalents thereof.

1. A method, comprising:
creating a device guaranteed unique identifier for a device located at a sub-system site when a guaranteed unique identifier does not already exist for the patient, where the device guaranteed unique identifier does not include information that indicates the actual identity of the device, wherein the device guaranteed unique identifier is generated as a thirty-two bit alpha-numeric string, and wherein the identifier is based on a random number and a predetermined clock seed;
creating a mapping between the device guaranteed unique identifier and the device;
receiving a message from a remote computing/storage service, which is located remote from the site, wherein the message includes the device guaranteed unique identifier and does not include information that indicates the actual identity of the device;
mapping the received message to the device guaranteed unique identifier at the site using the mapping;
conveying the message to the device, wherein the message includes an operation command that controls an operation of the device; and
changing the operation of the device based on the operation command.

2. The method of claim 1, further comprising:
conveying data, in electronic format, generated by the device from the device to a site server;
retrieving, by the site server, the device guaranteed unique identifier for the device;
removing or visually obscuring, by the site server, the patient identity and labeling the request with the guaranteed unique identifier corresponding to the patient identity;
transmitting, by the site server, the data along with the device guaranteed unique identifier, and without information that indicates the actual identity of the device, to the remote computing/storage service, which stores and/or processing the data;
wherein the message is transmitted to the device m response to a result from the processed data, where the message turns the device on or off.

3. (canceled)

4. (canceled)

5. (canceled)

6. (canceled)

7. A method, comprising:
receiving, at a site, patient data, in electronic format, for a patient at the site;
obtaining a guaranteed unique identifier that includes information that identifies the site;
at least one of removing or visually obscuring any information in the patient data that identifies the patient; and
conveying, electronically, the patient data and the guaranteed unique identifier to a remote computing/storage service, which stores the patient data along with the guaranteed unique identifier or stores the patient data without any information that identities the patient and processes the patient data, where results of the processed patient data are received by the site;
displaying the results on a display monitor, wherein the results are indicative of a comparison of patient data with standardized performance criteria;
and activating an alarm on the display monitor based on the results of the processed patient data.

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. The sub-system site of claim 1, further comprising:
a first data repository of the site, wherein the patient data is stored on the data repository with the patient identity or stored at a remote computing/storage service without the patient identity.

20. (canceled)

21. The sub-system site of claim 1, further comprising:
a computing device that generates a request for patient data based on the patient identity, wherein the site server removes and/or visually obscures the patient identity and labels the request with the guaranteed unique identifier corresponding to the patient identity.

22. The sub-system site of claim 1, wherein the site server receives the requested data corresponding to the guaranteed unique identifier, labels the received requested data with the patient identity, and provides the labeled received requested data to the computing device or to the remote computing/storage service.

23. (canceled)

24. (canceled)

25. A method, comprising:
waking a cloud based clinical decision support service (CDS) engine from an idle
instructing the clinical decision support service (CDS) engine to obtain patient data for a patient based on a corresponding guaranteed unique identifier*
receiving, at cloud based CDS system, a query from a healthcare entity of a group of federated healthcare entities or from a remote computing/storage service, wherein the query includes at least a guarantee unique identifier for a patient, which is generated by the healthcare entity, but does not include an identity of the patient;
identifying at least one guaranteed unique identifier stored on the cloud based CDS corresponding to another patient previously registered at another of the healthcare entities and likely to be a same patient as the queried patient, based on a score assignment analysis from a comparison of the attributes of the query and the patient previously registered at another of the healthcare entities corresponding to the at least one guaranteed unique identifier;
sorting the at least two guaranteed unique identifiers based on score;
generating a signal indicative of the at least one guaranteed unique identifier of the patient previously registered at the other of the healthcare entity; and
sending the signal to the querying healthcare entity or the remote computing/storage service.

26. The method of claim 25, wherein the queried patient is a first time registered patient of the healthcare entity.

27. (canceled)

28. (canceled)

29. (canceled)

30. The method of claim 25, further comprising:
receiving, at the cloud based CDS system, a second signal from the healthcare entity indicating acceptance of one of the GUIDs in the signal as corresponding to the same as the patient of the query.

31. The method of claim 30, further comprising:
obtaining a master GUID corresponding to the accepted GUID; and
updating the master GUID to include the GUID of the query.

32. The method of claim 30, further comprising:
notifying at least one entity of the federated healthcare entities that the master GUID, which includes a GUID generated by the at least one entity, that the master GUID is updated with a new GUID.

33. The method of claim 1, further comprising:
receiving, at the cloud based CDS system, a third signal from the healthcare entity indicating rejection of all of the GUIDs in the signal as corresponding to the same as the patient of the query; and
generating a new master GUID for the patient, wherein the master GUID includes the GUID of the query.

34. (canceled)

35. (canceled)

36. The method of claim 1, further comprising:
retrieving other GUIDs included in the master GUID;
wherein the signal includes the retrieved other GUIDs;
receiving, at the cloud based CDS system, a fourth signal from the healthcare entity indicating acceptance of one of the GUIDs in the signal as corresponding to the same as the patient of the query;
updating the master GUID to include the GUID of the query: and
generating a new master GUID for the patient, wherein the master GUID includes the GUID of the query.

37. (canceled)

38. (canceled)

39. (canceled)

40. (canceled)

41. (canceled)

42. (canceled)

43. The method of claim 41, wherein the user GUID does not already exist, and further comprising: generating the user GUID.

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. The method of claim 1, further comprising:
receiving a query from the remote computing/storage service for patient data corresponding to a first guaranteed unique identifier;
obtaining a first patient identity corresponding to the first guaranteed unique identifier, wherein the first patient identity corresponds to a first patient; and
retrieving patient data corresponding to the first patient based on the first patient identity, wherein the retrieved patient data, is the conveyed labeled patient data.

56. The method of claim 1, further comprising:
receiving a query from a remote application executed on a computing device for second patient data corresponding to a second patient based on a second patient identity;
obtaining a second guaranteed unique identifier corresponding to a second patient identity;
replacing a patient identity of the second patient in the request with the second guaranteed unique identifier, generating a modified query; and
conveying the modified query to the remote computing/storage service, wherein second patient is not identifiable from the request to the remote computing/storage service.

57. The method of claim 1, further comprising:
receiving the queried pattern data from the remote computing/storage service; obtaining the second patient identity corresponding to the second guaranteed unique identifier
replacing the second guaranteed unique identifier in the data with a patient identity of the second patient, generating a modified requested data.; and
conveying the modified requested data to the remote application, wherein second patient is identifiable from, the data based on the second patient identity.

58. The method of claim 1, wherein the patient data is stored locally at different sub-system sites.

59. The method of claim 1, wherein the patient data is stored in common storage at the remote computing/storage service.

60. The method of claim 1, further comprising:
processing the received data based on predetermined, performance criteria;
generating performance results; and
storing the performance results, wherein the stored performance results are indicative of a comparison of patient data from an individual site with standardized performance criteria or indicative of a comparison of patient data from two different sites;
generating performance criteria, based on the performance results; and
sending a message to the remote application based on the performance results.
